(19) United States
(12) Patent Application Publication
(10) Pub. No.: US 2025/0191273 A1
(43) Pub. Date: Jun. 12, 2025

(54) GENERATING TEXTURES FROM TEXT AND MODELS

(71) Applicants: Sergei Korolev, Marina del Rey, CA (US); Vladislav Shakhrai, London (GB); Mikhail Vasilkovskii, London (GB)

(72) Inventors: Sergei Korolev, Marina del Rey, CA (US); Vladislav Shakhrai, London (GB); Mikhail Vasilkovskii, London (GB)

(21) Appl. No.: 18/533,877

(22) Filed: Dec. 8, 2023

(51) Int. Cl. G06T 15/04; G06F 40/40; G06T 15/50; G06T 17/20

(52) U.S. Cl. CPC G06T 15/04; G06F 40/40; G06T 15/50; G06T 17/20

(57) ABSTRACT

A three-dimensional (3D) texture is generated for an input 3D model based on input text describing the desired texture. Example methods include rendering the 3D model and trainable 3D texture to generate a first two-dimensional (2D) image, adding noise to the first 2D image to generate a first 2D image with added noise, and inputting the first 2D image with added noise and input text into a trained neural network to generate a predicted noise of the first 2D image with added noise. The methods further include determining a loss between the first 2D image with added noise and the predicted noise and updating the trainable 3D texture based on the loss. The method is repeated for a number of time or until a loss between the first 2D image and the predicted noise transgresses a threshold.

### TECHNICAL FIELD

Examples of the present disclosure relate generally to generative artificial intelligence (AI) applications or generative neural networks (NN), where a three-dimensional (3D) texture for a 3D model is generated or iteratively improved based on inputs of the 3D model and input text describing the 3D texture.

### BACKGROUND

AI applications have become ubiquitous. And users increasingly want more and more functionality from the AI applications and for the functionality to be easier to use. But often it is difficult to add the functionality.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system, according to some examples, that has both client-side and server-side functionality.

FIG. 3 is a diagrammatic representation of a data structure as maintained in a database, according to some examples.

FIG. 4 is a diagrammatic representation of a machine in the form of a computer system within which a set of instructions may be executed to cause the machine to perform any one or more of the methodologies discussed herein, according to some examples.

FIG. 5 is a block diagram showing a software architecture within which examples may be implemented.

FIG. 6 illustrates a generate texture component, in accordance with some examples.

FIG. 7 illustrates a system for generating textures from text and models, in accordance with some examples.

FIG. 8 illustrates loss determination, in accordance with some examples.

FIG. 9 illustrates the trained NN, in accordance with some examples.

FIG. 10 illustrates an example 3D texture generation application, in accordance with some examples.

FIG. 11 illustrates a method for generating 3D textures, in accordance with some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

Producing 3D textures is often difficult and requires familiarity with applications that can be difficult to learn. For example, for a user to produce a 3D texture of a house, the user may have to use sophisticated 3D modeling software. However, the demand for 3D textures continues to grow as websites and marketing becomes more and more sophisticated. Additionally, the users often would like the 3D textures to be generated from a textual description of the 3D texture.

For example, the 3D model may be of a house and the input text may be “a brick house.” The goal is to generate a 3D texture for the 3D model so that when the 3D model and the 3D texture are rendered from an arbitrary angle that the result is a “brick house.”

A technical challenge is that the computational requirements may be prohibitive for training a generative AI system to generate 3D textures for 3D models based on a textural description. The technical challenge is addressed by using a generative NN trained to generate 2D images from input text and updating an initial 3D texture based on the output of the generative NN compared with the 3D model rendered with the initial 3D texture.

More particularly, but not by way of limitations, examples of the present disclosure relate to a method that begins with accessing an input 3D model and input text describing a 3D texture for the 3D model. Then, a differentiable renderer is used with input of a random or initial 3D texture and the 3D model to generate an output 2D image.

Gaussian noise is then added to the output 2D image to generate an output 2D image with noise. The output 2D image with noise and the input text are input into the trained NN, which generates a predicted noise. The trained NN is a stable diffusion model for generating 2D images from a textual description. The trained NN model generates a predicted noise.

The predicted noise is an indication of how far the output 2D image with noise is, within the latent space of the trained NN, from being a 2D image in accordance with the input text. Gradients are then determined based on a comparison of the predicted noise with the output 2D image with noise or with just the noise added to the 2D image. The gradients may also be determined based on the predicted noise being subtracted from the 2D image with noise.

The gradients are propagated or backpropagated through the output 2D image, the differentiable renderer, and the trainable 3D texture. The trainable 3D texture is improved by the backpropagation. This method is repeated a number of times or until the difference between the predicted loss and the added noise is below a threshold or transgresses a threshold.

Additionally, in some examples, the method is repeated for different camera angles used by the renderer and the input text is modified to agree with the camera angle. For example, the camera angle may be looking down at the 3D house, so the input text is modified to “looking down on a brick house.” In some examples, different lighting information may be used by the renderer. For example, a single bright light source at a position of x=0, y=0, and z=10 meters from the 3D model. The input text may be modified to reflect the light source such as “looking down on a brick house with a light source shining down on the house.” Many different camera angles and light sources may be used so that the 3D texture may be used from any angle of the 3D model.

Moreover, the amount of Gaussian noise added to the output 2D image may be varied in accordance with a number of iterations performed of the method with more Gaussian noise being added for later iterations.

### Networked Computing Environment

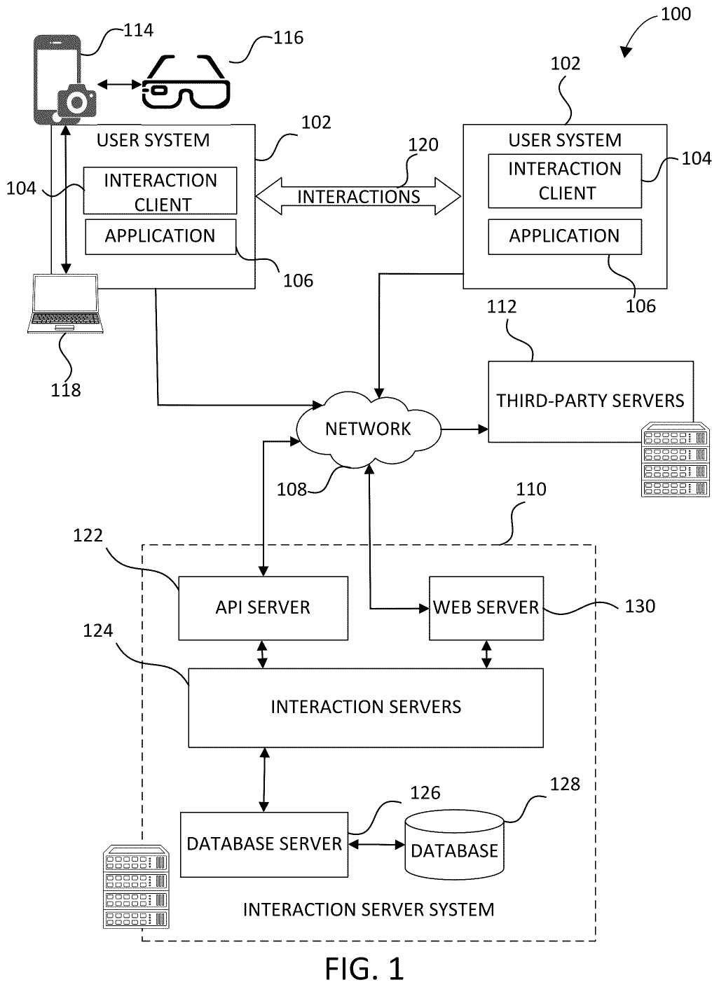

FIG. 1 is a block diagram showing an example interaction system 100 for facilitating interactions (e.g., exchanging text messages, conducting text audio and video calls, or playing games) over a network. The interaction system 100 includes multiple client systems, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems), an interaction platform 110 and third-party servers 112). An interaction client 104 can also communicate with locally hosted applications 106 using Applications Program Interfaces (APIs).

Each user system 102 may include multiple user devices, such as a computing device 114, head-wearable apparatus 116, and a computer client device 118 that are communicatively connected to exchange data and messages. In some examples, the head-wearable apparatus 116 device is termed augmented reality (AR), mixed reality (MR), virtual reality (VR), and/or extended reality (XR) glasses.

An interaction client 104 interacts with other interaction clients 104 and with the interaction platform 110 via the network 108. The data exchanged between the interaction clients 104 (e.g., interactions 120) and between the interaction clients 104 and the interaction platform 110 includes functions (e.g., commands to invoke functions) and payload data (e.g., text, audio, video, or other multimedia data).

The interaction platform 110 provides server-side functionality via the network 108 to the interaction clients 104. While certain functions of the interaction system 100 are described herein as being performed by either an interaction client 104 or by the interaction platform 110, the location of certain functionality either within the interaction client 104 or the interaction platform 110 may be a design choice. For example, it may be technically preferable to initially deploy particular technology and functionality within the interaction platform 110 but to later migrate this technology and functionality to the interaction client 104 where a user system 102 has sufficient processing capacity.

The interaction platform 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, social network information, and live event information. Data exchanges within the interaction system 100 are invoked and controlled through functions available via user interfaces (UIs) of the interaction clients 104.

Turning now specifically to the interaction platform 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

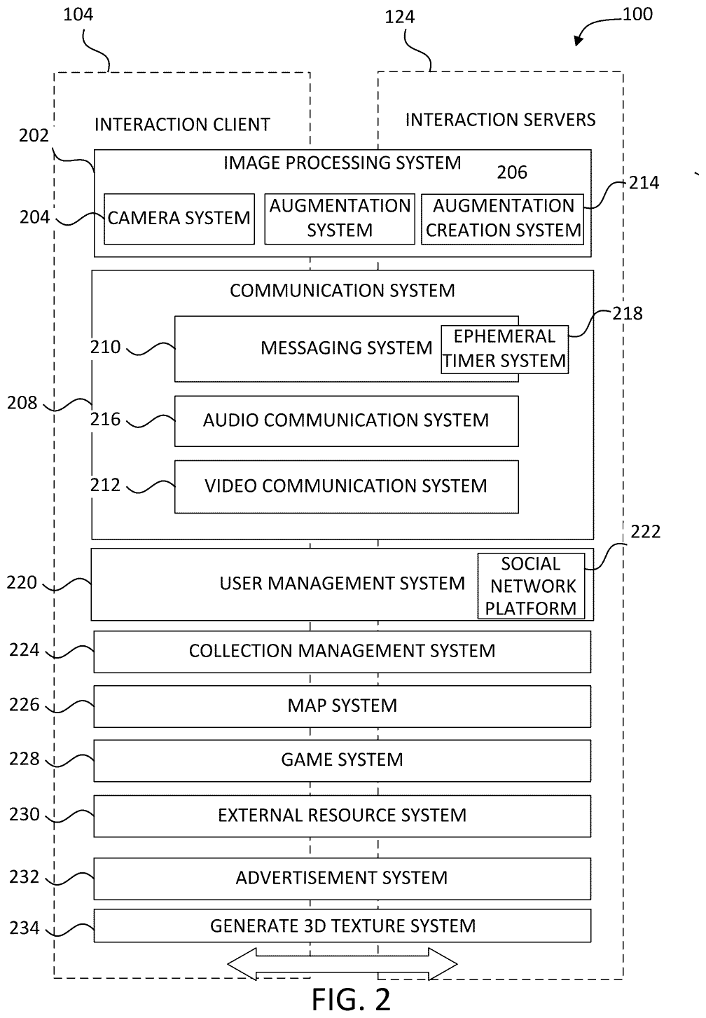

The Application Program Interface (API) server 122 receives and transmits interaction data (e.g., commands and message payloads) between the interaction servers 124 and the client systems (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity graph (e.g., a social graph); the location of friends within a social graph; and opening an application event (e.g., relating to the interaction client 104). The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104. The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally-installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally-installed application 106, the interaction client 104 instructs the user system 102 to launch the external resource by executing locally-stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory 406 of a user system 102. These augmentations are selected by the augmentation system 206 and presented to a user of an interaction client 104, based on a number of inputs and data, such as for example:
Geolocation of the user system 102; and
Social network information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system 218) that, based on duration and display parameters associated with a message or collection of messages (e.g., a story), selectively enable access (e.g., for presentation and display) to messages and associated content via the interaction client 104. Further details regarding the operation of the ephemeral timer system 218 are provided below. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 220 is operationally responsible for the management of user data and profiles, and includes an interaction platform that maintains information regarding relationships between users of the interaction system 100.

A collection management system 224 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 224 may also be responsible for publishing an icon that provides notification of a particular collection to the user interface of the interaction client 104. The collection management system 224 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 224 employs machine vision (or image recognition technology) and content rules to curate a content collection automatically. In certain examples, compensation may be paid to a user to include user-generated content into a collection. In such cases, the collection management system 224 operates to automatically make payments to such users to use their content.

A map system 226 provides various geographic location functions and supports the presentation of map-based media content and messages by the interaction client 104. For example, the map system 226 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 228 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 230 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction platform 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A WebViewJavaScriptBridge running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 232 operationally enables the purchasing of advertisements by third parties for presentation to end-users via the interaction clients 104 and also handles the delivery and presentation of these advertisements.

The generating 3D texture system 234 supports or is the same as the generate texture component 602 and/or the 3D texture generator application 1010. In some examples, the generate 3D texture system 234 performs one or more functions for the training component 602 and/or the 3D texture generator application 1010.

Additionally, the generate 3D texture system 234 can provide the 3D texture generator application 1010 to user systems 102 and/or head-wearable apparatuses 116. The generate 3D texture system 234 interacts with the social network platform 222 by providing services such as lists of available 3D mesh inputs 604, text inputs 603, and by delivering them to user systems 102 and/or head-wearable apparatuses 116.

### Data Architecture

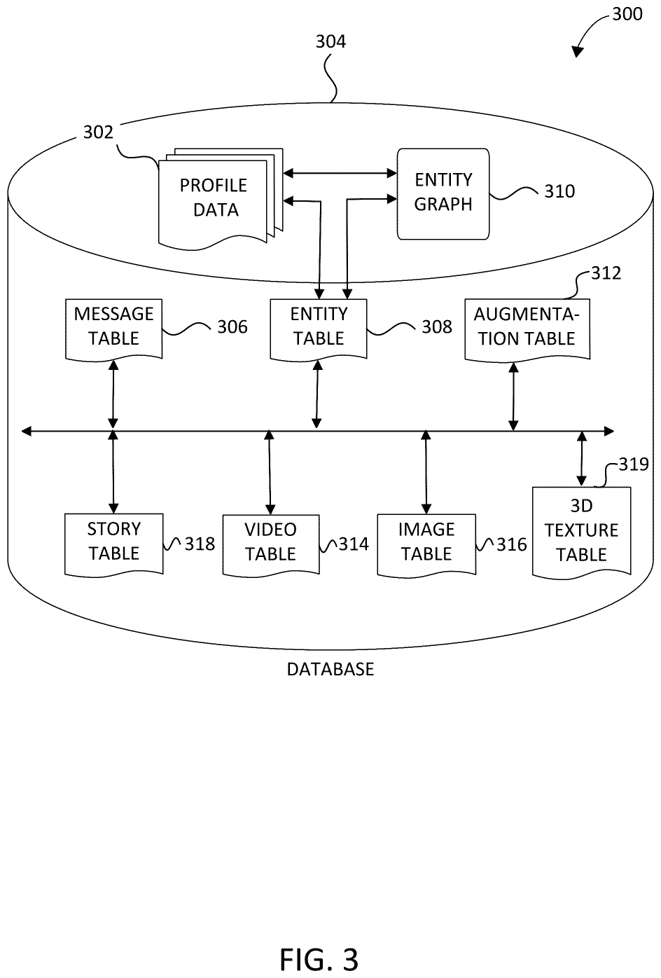

FIG. 3 is a schematic diagram illustrating data structures 300, which may be stored in the database 304 of the interaction platform 110, according to certain examples. While the content of the database 304 is shown to comprise multiple tables, it will be appreciated that the data could be stored in other types of data structures (e.g., as an object-oriented database).

The database 304 includes message data stored within a message table 306. This message data includes, for any particular message, at least message sender data, message recipient (or receiver) data, and a payload. Further details regarding information that may be included in a message and included within the message data stored in the message table 306, are described below with reference to FIG. 3.

An entity table 308 stores entity data, and is linked (e.g., referentially) to an entity graph 310 and profile data 302. Entities for which records are maintained within the entity table 308 may include individuals, corporate entities, organizations, objects, places, events, and so forth. Regardless of entity type, any entity regarding which the interaction platform 110 stores data may be a recognized entity. Each entity is provided with a unique identifier, as well as an entity type identifier (not shown).

The entity graph 310 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 308. Such privacy settings may be applied to all types of relationships within the context of the interaction system 100, or may selectively be applied to certain types of relationships.

The profile data 302 stores multiple types of profile data about a particular entity. The profile data 302 may be selectively used and presented to other users of the interaction system 100 based on privacy settings specified by a particular entity. Where the entity is an individual, the profile data 302 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 304 also stores augmentation data, such as overlays or filters, in an augmentation table 312. The augmentation data is associated with and applied to videos (for which data is stored in a video table 314) and images (for which data is stored in an image table 316).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 316 includes augmented reality content items (e.g., corresponding to applying “lenses” or augmented reality experiences). An augmented reality content item may be a real-time special effect and sound that may be added to an image or a video.

A story table 318 stores data regarding collections of messages and associated image, video, or audio data, which are compiled into a collection (e.g., a story or a gallery). The creation of a particular collection may be initiated by a particular user (e.g., each user for which a record is maintained in the entity table 308). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 314 stores video data that, in some examples, is associated with messages for which records are maintained within the message table 306. Similarly, the image table 316 stores image data associated with messages for which message data is stored in the entity table 308. The entity table 308 may associate various augmentations from the augmentation table 312 with various images and videos stored in the image table 316 and the video table 314.

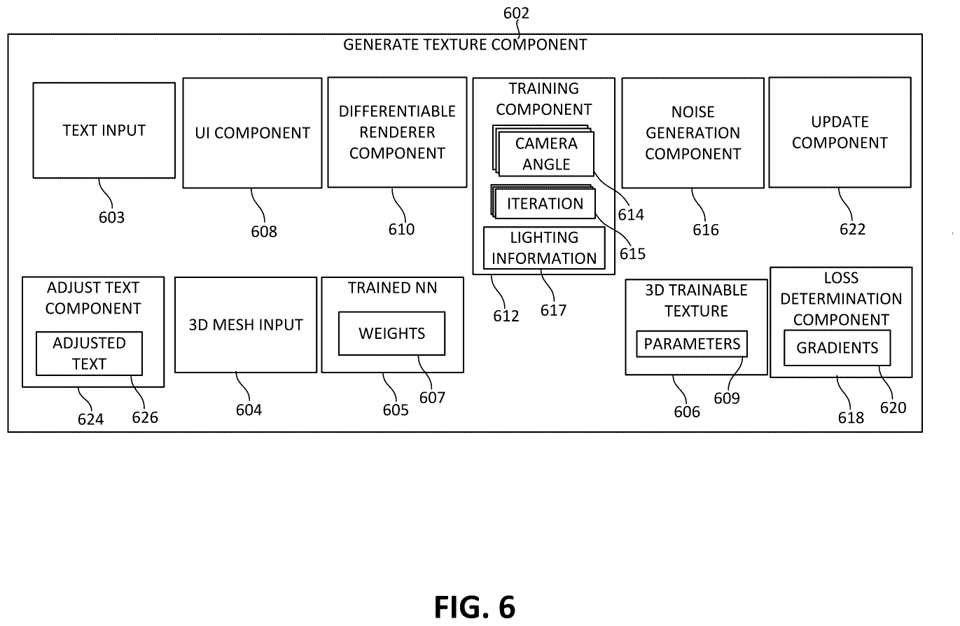

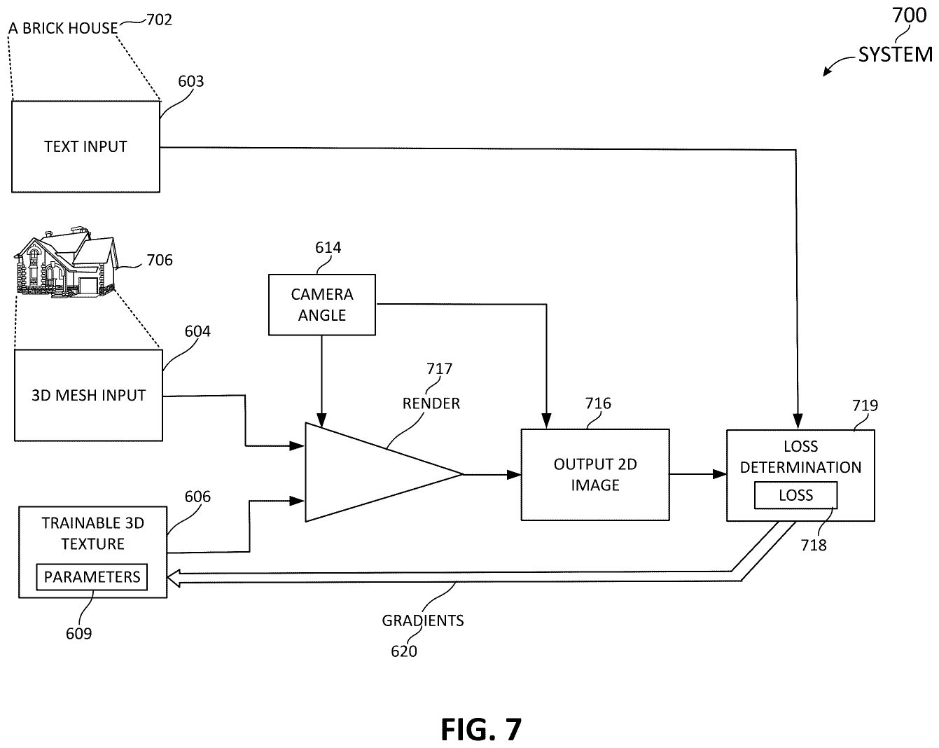

The databases 304 also includes 3D texture table 319. The 3D texture table 319 includes, referring to FIGS. 6 and 7, trained NN 605, 3D mesh input 604, 3D trainable texture 606, 3D texture generator application 1010, and so forth.

### Machine Architecture

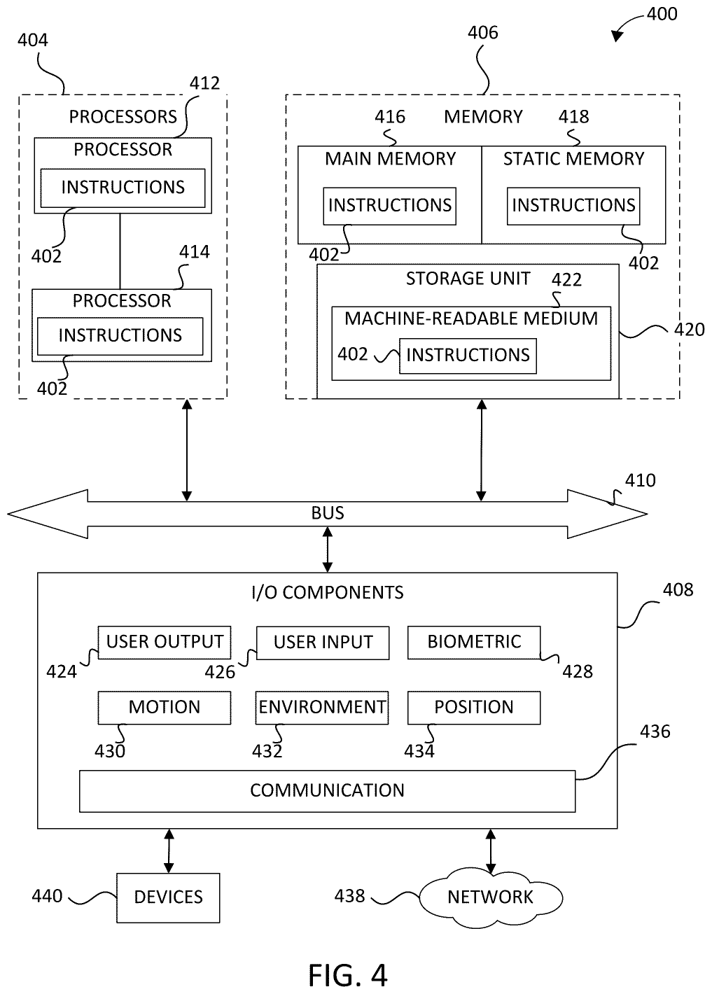

FIG. 4 is a diagrammatic representation of the machine 400 within which instructions 402 (e.g., software, a program, an application, an applet, an app, or other executable code) for causing the machine 400 to perform any one or more of the methodologies discussed herein may be executed. For example, the instructions 402 may cause the machine 400 to execute any one or more of the methods described herein. The instructions 402 transform the general, non-programmed machine 400 into a particular machine 400 programmed to carry out the described and illustrated functions in the manner described. The machine 400 may operate as a standalone device or may be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 402, sequentially or otherwise, that specify actions to be taken by the machine 400. Further, while a single machine 400 is illustrated, the term “machine” shall also be taken to include a collection of machines that individually or jointly execute the instructions 402 to perform any one or more of the methodologies discussed herein. The machine 400, for example, may comprise the user system 102 or any one of multiple server devices forming part of the interaction platform 110. In some examples, the machine 400 may also comprise both client and server systems, with certain operations of a particular method or algorithm being performed on the server-side and with certain operations of the particular method or algorithm being performed on the client-side.

The machine 400 may include processors 404, memory 406, and input/output I/O components 408, which may be configured to communicate with each other via a bus 410. In an example, the processors 404 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 412 and a processor 414 that execute the instructions 402. The term “processor” is intended to include multi-core processors that may comprise two or more independent processors (sometimes referred to as “cores”) that may execute instructions contemporaneously. Although FIG. 4 shows multiple processors 404, the machine 400 may include a single processor with a single-core, a single processor with multiple cores (e.g., a multi-core processor), multiple processors with a single core, multiple processors with multiples cores, or any combination thereof.

The memory 406 includes a main memory 416, a static memory 418, and a storage unit 420, both accessible to the processors 404 via the bus 410. The main memory 406, the static memory 418, and storage unit 420 store the instructions 402 embodying any one or more of the methodologies or functions described herein. The instructions 402 may also reside, completely or partially, within the main memory 416, within the static memory 418, within machine-readable medium 422 within the storage unit 420, within at least one of the processors 404 (e.g., within the processor's cache memory), or any suitable combination thereof, during execution thereof by the machine 400.

The I/O components 408 may include a wide variety of components to receive input, provide output, produce output, transmit information, exchange information, capture measurements, and so on. The specific I/O components 408 that are included in a particular machine will depend on the type of machine. For example, portable machines such as mobile phones may include a touch input device or other such input mechanisms, while a headless server machine will likely not include such a touch input device. It will be appreciated that the I/O components 408 may include many other components that are not shown in FIG. 4. In various examples, the I/O components 408 may include user output components 424 and user input components 426. The user output components 424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 408 may include biometric components 428, motion components 430, environmental components 432, or position components 434, among a wide array of other components. For example, the biometric components 428 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 430 include acceleration sensor components (e.g., accelerometer), gravitation sensor components, rotation sensor components (e.g., gyroscope).

The environmental components 432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 434 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 408 further include communication components 436 operable to couple the machine 400 to a network 438 or devices 440 via respective coupling or connections. For example, the communication components 436 may include a network interface component or another suitable device to interface with the network 438. In further examples, the communication components 436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 440 may be another machine or any of a wide variety of peripheral devices (e.g., a peripheral device coupled via a USB).

Moreover, the communication components 436 may detect identifiers or include components operable to detect identifiers. For example, the communication components 436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 436, such as location via Internet Protocol (IP) geolocation, location via Wi-Fi® signal triangulation, location via detecting an NFC beacon signal that may indicate a particular location, and so forth.

The various memories (e.g., main memory 416, static memory 418, and memory of the processors 404) and storage unit 420 may store one or more sets of instructions and data structures (e.g., software) embodying or used by any one or more of the methodologies or functions described herein. These instructions (e.g., the instructions 402), when executed by processors 404, cause various operations to implement the disclosed examples.

The instructions 402 may be transmitted or received over the network 438, using a transmission medium, via a network interface device (e.g., a network interface component included in the communication components 436) and using any one of several well-known transfer protocols (e.g., hypertext transfer protocol (HTTP)). Similarly, the instructions 402 may be transmitted or received using a transmission medium via a coupling (e.g., a peer-to-peer coupling) to the devices 440.

### Software Architecture

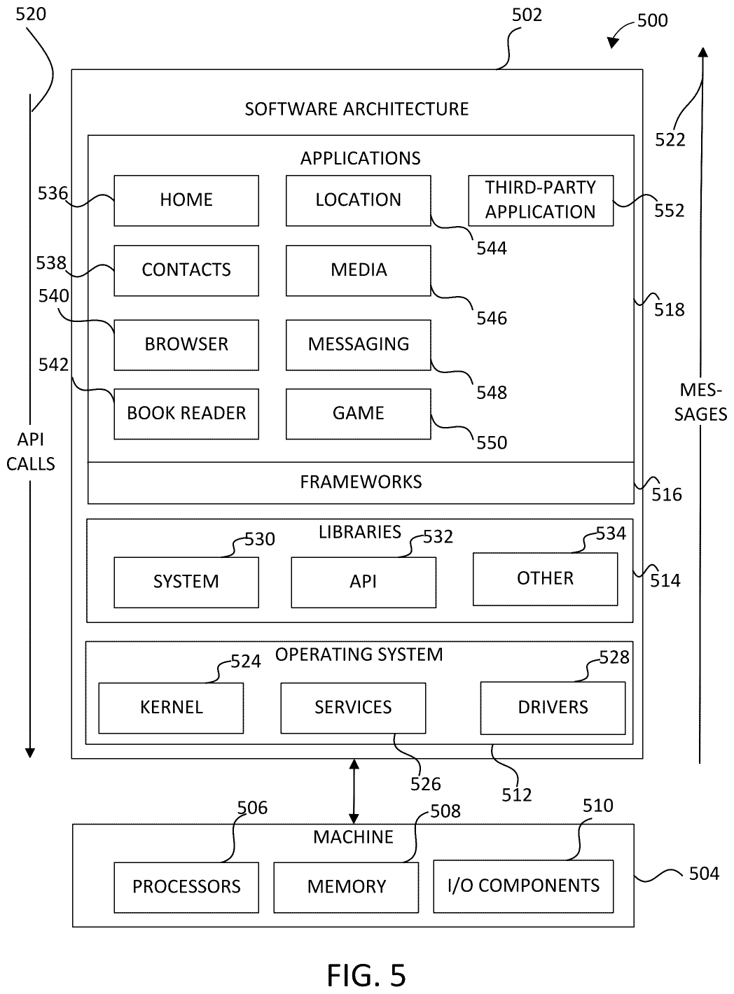

FIG. 5 is a block diagram 500 illustrating a software architecture 502, which can be installed on any one or more of the devices described herein. The software architecture 502 is supported by hardware such as a machine 504 that includes processors 506, memory 508, and I/O components 510. In this example, the software architecture 502 can be conceptualized as a stack of layers, where each layer provides a particular functionality. The software architecture 502 includes layers such as an operating system 512, libraries 514, frameworks 516, and applications 518. Operationally, the applications 518 invoke API calls 520 through the software stack and receive messages 522 in response to the API calls 520.

The operating system 512 manages hardware resources and provides common services. The operating system 512 includes, for example, a kernel 524, services 526, and drivers 528. The kernel 524 acts as an abstraction layer between the hardware and the other software layers. For example, the kernel 524 provides memory management, processor management (e.g., scheduling), component management, networking, and security settings, among other functionalities. The services 526 can provide other common services for the other software layers. The drivers 528 are responsible for controlling or interfacing with the underlying hardware. For instance, the drivers 528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 514 provide a common low-level infrastructure used by the applications 518. The libraries 514 can include system libraries 530 (e.g., C standard library) that provide functions such as memory allocation functions, string manipulation functions, mathematic functions, and the like. In addition, the libraries 514 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 514 can also include a wide variety of other libraries 534 to provide many other APIs to the applications 518.

The frameworks 516 provide a common high-level infrastructure that is used by the applications 518. For example, the frameworks 516 provide various graphical user interface (GUI) functions, high-level resource management, and high-level location services. The frameworks 516 can provide a broad spectrum of other APIs that can be used by the applications 518, some of which may be specific to a particular operating system or platform.

In an example, the applications 518 may include a home application 536, a contacts application 538, a browser application 540, a book reader application 542, a location application 544, a media application 546, a messaging application 548, a game application 550, and a broad assortment of other applications such as a third-party application 552. The applications 518 are programs that execute functions defined in the programs. Various programming languages can be employed to create one or more of the applications 518, structured in a variety of manners, such as object-oriented programming languages (e.g., Objective-C, Java, or C++) or procedural programming languages (e.g., C or assembly language). In a specific example, the third-party application 552 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 552 can invoke the API calls 520 provided by the operating system 512 to facilitate functionalities described herein.

Generating Texture from Text and Models

FIG. 6 illustrates a generate texture component 602, in accordance with some examples. The generate texture component 602 generates a texture such as 3D trainable texture 606 from text input 603 and a model such as 3D mesh input 604. In some examples, the generate texture component 602 generates a different dimensional texture such as a 1D or 2D texture.

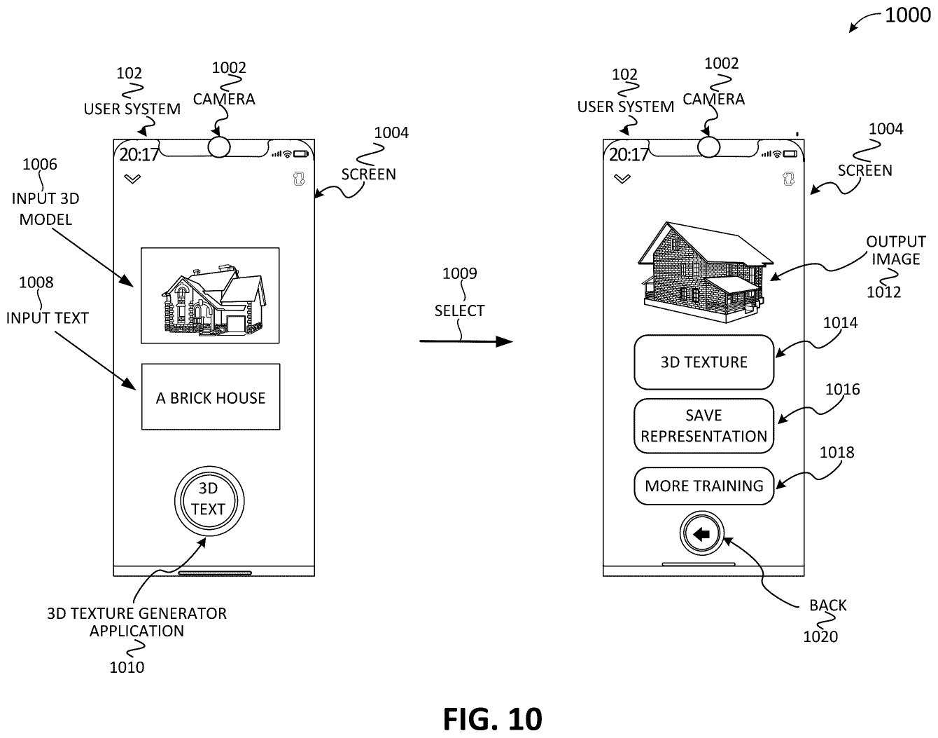

The user interface (UI) component 608 accesses text input 603 and a 3D mesh input 604. In some examples, the text input 603 and the 3D mess input 604 are inputs from a user and the UI component 608 provides a UI such as the one illustrated in FIG. 10 for the user to provide the text input 603 and the 3D mess input 604. The 3D trainable texture 606 is the output of the generate texture component 602 and is a 3D texture for the 3D mess input 604 in accordance with the text input 603. For example, if the 3D mess input 604 is a 3D mess of a house 706 as illustrated in FIG. 7 and the text input 603 is “brick house,” then the output is the 3D trainable texture 606, which is a 3D texture that can be used by a renderer to turn the 3D mess input 604, which is the “house”, into a “brick house” such as output image 1012 of FIG. 10.

The 3D mesh input 604 is a representation of a 3D model such as signed distance functions (SDFs), 3D Manufacturing Format, Blender® format, irregular voxel format, and so forth. The 3D trainable texture 606 is a texture representation where a surface color can be determined from the 3D trainable texture 606 based on a 3D coordinate. In some examples, the 3D trainable texture 606 is an existing UV map, a UV map generated by the 3D texture generator component 602, an implicit 3D representation using hash-grid positional encodings, or another representation. The parameters 609 are the values associated with the 3D trainable texture 606 and are updated by the update component 622.

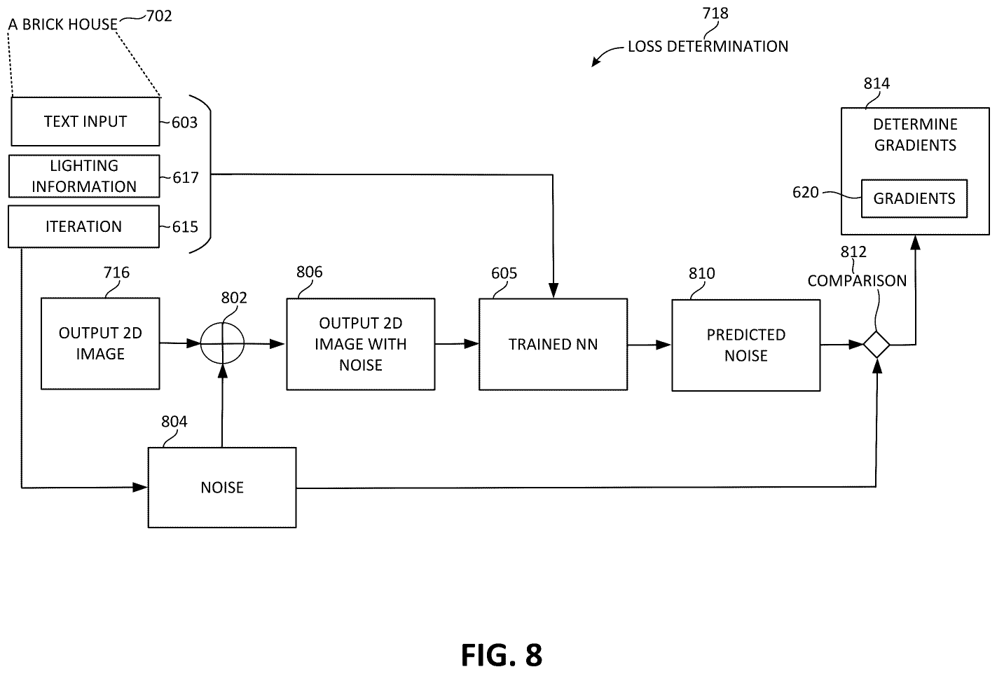

The trained NN 605 is a trained neural network, which takes text and produces a 2D image based on the text. For example, a text input 603 of “astronaut on a horse” may produce a 2D image of an astronaut riding a white horse on the moon. In some examples, the trained NN 605 is a diffusion model where noise is input with the text input 603 and the output is the predicted noise 810 of FIG. 8. The trained NN 605 has an architecture similar to U-Net with convolutional layers, down sampling, up sampling, cross layers, fully connected layers, and so forth, in accordance with some examples. The weights 607 of the trained NN 605 enable the trained NN 605 to generate a 2D image from text input 603.

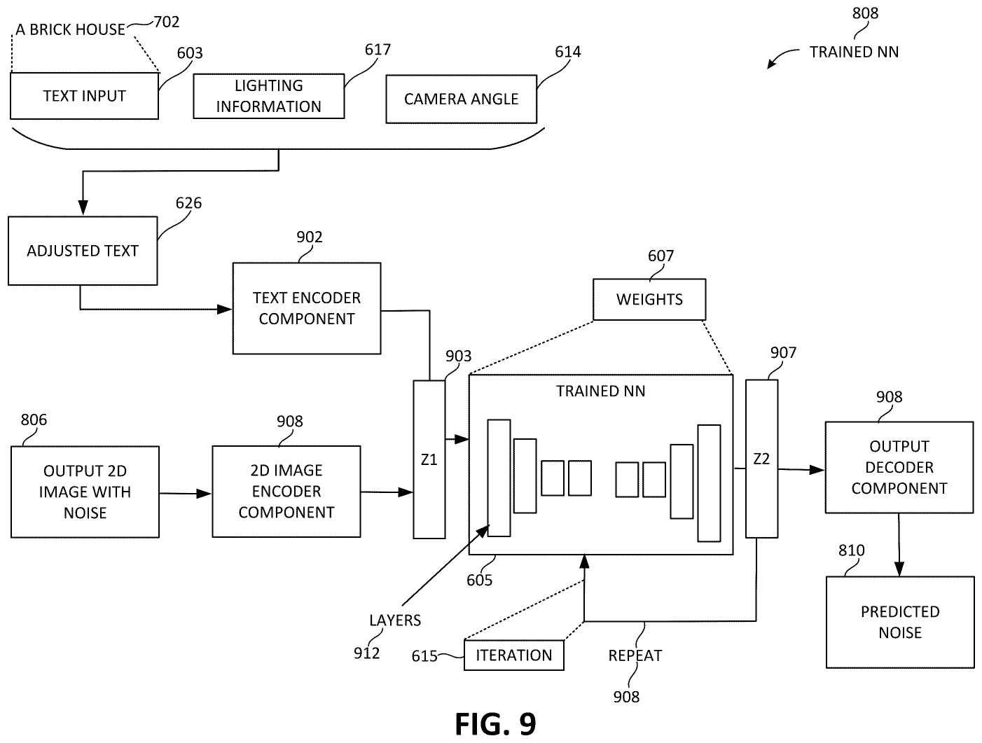

In some examples, the trained NN 605 is trained to take input 2D noise, such as Gaussian noise, and text input 603, and output predicted noise 810 of FIG. 9. The predicted noise 810 is subtracted from the input 2D noise and the process is repeated a predetermined number of times or a number of times until the difference between the output and the input 2D noise is below or transgresses a threshold. The input 2D noise in this way is transformed into the 2D image representing the text input 603. In each iteration, the text input 603 is encoded and input into one or more of the layers 912 of the trained NN 605. In some examples, in each iteration, an iteration 615 value is encoded and feed into one or more layers 912 of the trained NN. The iteration 615 may indicate a level of Gaussian noise that was added during training to a ground truth input, which the trained NN 605 is learning to denoise.

The text encoder component 902 of FIG. 9 takes the text and encodes it into latent space Z1 903 and inputs the encoded text into one or more of the layers 912 of the trained NN 605. In some examples, an encoding such as Word2Vec is used. The latent space Z1 903, in some examples, is a lower dimensional latent space to reduce the complexity of training the trained NN 605.

The differentiable renderer component 610 is a differential renderer that permits the gradients 620 to be backpropagated through the differential renderer component 610 to the 3D trainable texture 606, so the parameters 609 of the 3D trainable texture 606 can be updated based on the gradients 620. The noise generation component 616 generates noise such as noise 804 of FIG. 8 that is added to rendered 2D output image such as output 2D image 716 of FIG. 7. The adjust text component 624 adjusts the text input 603 in accordance with the camera angle 614 and/or lighting information 617. For example, if the camera angle 614 is from a top perspective and the text input 603 is “brick house”, then the adjust text component 624 adjusts the text 626 to “a brick house looking from above.” Other examples of the adjusted text 626 include “in a front view”, “in a side view”, “looking up at”, “looking down at”, and so forth. In some examples, the adjust text component 624 indicates in the text the camera angle 614 such as indicating x, y, and z coordinates of the camera relative to the 3D mesh input 604.

Additionally, in some examples, lighting information 617 is used which includes lighting sources for the differentiable renderer component 610 to use in rendering the 3D trainable texture 606 and the 3D mess input 604. The adjust text component 624 analyzes the lighting information 617 and adjusts the text input 603 accordingly. For example, the lighting information 617 may be for the lighting to be a uniform white light. The adjust text component 624 includes text to indicate that the “brick house” should have “uniform white light” such as “a brick house looking from above with uniform white light.” The adjust text component 624 may adjust the text input 603 in accordance with the lighting information 617 by adding text such as “in twilight”, “in the dark”, “during a setting sun”, “in moon light”, “during the day”, “during the evening”, “in bright noon sunlight,” and so forth. In some examples, the adjust text component 624 indicates in the adjusted text 626 the lighting information 617 such as a number of lighting sources, intensities of the light sources, and the type of light for the light sources. For example, the adjusted text 626 may be “a brick house with one lighting source with red light with the lighting source at position x, y, and z.”

The loss determination component 618 determines gradient 620 based on a difference between the predicted noise such as predicted noise 810 of FIG. 8 and noise 804 generated by the noise generation component 616. The update component 622 backpropagates the gradients 620 through one or more of: the output 2D image with noise 806 of FIG. 7, the output 2D image 716, and the differential renderer component 610 to update the 3D trainable texture 606.

FIG. 7 illustrates a system 700 for generating textures from text and models, in accordance with some examples. The training component 612 trains the trainable 3D texture 606 by iterating the following operations one or more times. Referring to FIGS. 6 and 7, the differential renderer component 610 renders 717 output 2D image 716 from the 3D mesh input 604, the trainable 3D texture 606, a camera angle 614, and, optionally, lighting information 617. The training component 612 selects different camera angles 614 and/or lighting information 617 during different iterations of training to include a variety of camera angles 614 to train the 3D trainable texture 606.

After rendering the output 2D image 716, the loss determination component 618 determines the gradients 620 based on the loss 718. The operations for the loss determination 719 that determines the loss 718 are disclosed in conjunction with FIGS. 8 and 9.

The update component 622 backpropagates or propagates the gradients 620 to update the trainable 3D texture 606. The training component 612 repeats these operations until the loss 718 transgresses or is below a threshold value, in accordance with some examples. In some examples, the training component 612 performs these operations a predetermined number of times.

FIG. 8 illustrates loss determination 719, in accordance with some examples. The noise generation component 616 generates noise 804. The training component 612 combines 802 the noise 804 to the output 2D image 716 to generate the output 2D image with the noise 806. The training component 612 inputs the output 2D with noise 806 and the text input 603, which may be “a brick house” 702, into the trained NN 808 to generate the predicted noise 810. The loss determination component 814 determines the gradients 620 based on a comparison 812 between the predicted noise 810 with the noise 804. The comparison 812 is a difference, in accordance with some examples. In some examples, the loss determination component 814 determines the gradients 620 based on a comparison 812 between the predicted noise 810 and the output 2D image with noise 806. In some examples, the loss determination component 814 uses the lighting information 617 and/or the iteration 615 in determining the gradients 620. Additionally, in some examples, the noise generation component 616 generates the noise 804 based on an iteration 615. In some examples, the amount of noise 804 is greater in each subsequent iteration 615.

FIG. 9 illustrates the trained NN 808, in accordance with some examples. The adjust text component 624 generates the adjusted text 626 from text input 603 and, optionally, the lighting information 617 and/or the camera angle 614. In some examples, the text encoder component 902 takes as input the adjusted text 626 generated by the adjust text component 624 and encodes the adjusted text 626 into the latent space Z1 903 as disclosed herein. The encoded text is input to one or more layers 912 of the trained NN 605. The 2D image encoder component 908 encodes the output 2D image with noise 806 into the latent space Z1 903. The training component 612 inputs the encoded output 2D image with noise 806, the encoded adjusted text 626, and, optionally, the iteration 615, into the trained NN 605, which produces a result in the latent space Z2 907. The output decoder component 908 decodes the result to generate the predicted noise 810. The trained NN 605 is trained, in accordance with some examples, to take as input the iteration 615, which is an indication of the amount of noise added to the output 2D image with noise 806.

FIG. 10 illustrates an example 3D texture generation application, in accordance with some examples. The user system 102 includes a camera 1002 and screen 1004. The user of the user system 102 inputs an input 3D model 1006 and input text 1008. The user then selects 1009 the 3D texture generator application 1010, which generates the 3D texture 1014. The user can select save representation 1016 to save a representation of the 3D texture 1014. The input 3D model 1006 is an image of the input 3D model 1006 being rendered. The output image 1012 is the input 3D model 1006 rendered with the 3D texture 1014. The user can select “more training” 1018, which will cause the 3D texture generator application 1010 to perform more iterations of training the 3D texture 1014. The user can select back 1020 to return to the previous screen 1004. The 3D texture generator application 1010 is an application that uses the generate texture component 602 to perform the functions disclosed herein.

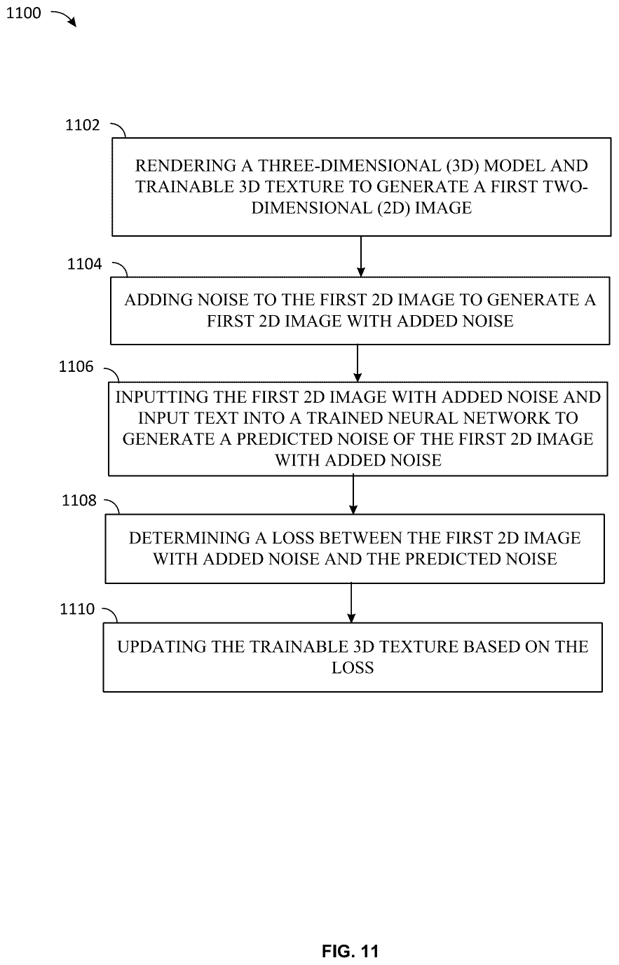

FIG. 11 illustrates a method for generating 3D textures, in accordance with some examples. The method 1100 begin at operation 1102 with rendering a 3D model and trainable 3D texture to generate a first 2D image. For example, referring to FIGS. 6 and 7, the differentiable renderer component 610 renders 717 the 3D mesh input 604 with the trainable 3D texture 606 to generate the output 2D image 716.

The method 1100 continues at operation 1104 with adding noise to the first 2D image to generate a first 2D image with added noise. For example, referring to FIGS. 6 and 8, noise generator component 616 generates noise 804, which may be based on the iteration 615, and the generate texture component 602 adds the noise 804 to the output 2D image 716 to generate the output 2D image with noise 806.

The method 1100 continues at operation 1106 with inputting the first 2D image with added noise and input text into a trained neural network to generate a predicted noise of the first 2D image with added noise. For example, referring to FIGS. 6, 8, and 9, the generate texture component 602 inputs the output 2D image with noise 806 and the adjusted text 626 into the trained NN 605 to generate the predicted noise 810. The adjust text component 624 takes as input one or more of the text input 603, the lighting information 617, and the camera angle 614 and generates the adjusted text 626. The adjusted text 626 may be encoded into the latent space Z1 903 by the text encoder component 902. The output 2D image with noise 806 may be encoded into the latent space Z1 903 by the 2D image encoder component 908. The predicted noise 810 may be decoded from latent space Z2 907 by the output decoder component 908. Additionally, the adjusted text 626 or encoded adjusted text 626 may be input into one or more layers 912 of the trained NN 605.

The method 1100 continues at operation 1108 with determining a loss between the first 2D image with added noise and the predicted noise. For example, referring to FIGS. 6, 7, and 8, loss determination component 618 performs a loss determination 719 to determine the loss 718. The loss determination component 618 determines the loss 718 based on a difference or a comparison 812 between the noise 804 and the predicted noise 810 to generate gradients 620, in accordance with some examples.

The method 1100 continues at operation 1110 with updating the trainable 3D texture based on the loss. For example, referring to FIGS. 6 and 7, the update component 622 backpropagates the gradients 620 through the output 2D image 716, differentiable renderer component 610 and trainable 3D texture 606. The update component 622 backpropagates the gradients 620 through the output 2D image with noise 806 less the predicted noise 810, in accordance with some examples. The method 1100 is repeated a number of times or until the difference between the predicted noise 810 and the noise 804 is less than or transgresses a threshold.

The method 1100 optionally includes one or more additional operations, the operations of method 1100 can be performed in a different order, or one or more of the operations of the method 1100 can be optional. The method 1100 may be performed in whole or in part by one or more computing devices, or an apparatus of one or more computing devices disclosed herein. The functions of a component, such as the generate training component 602, are performed or executed by one or more computing devices configured to perform or execute the functions of the component.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” or “module” refers, for example, to a device, physical entity, or logic having boundaries defined by function or subroutine calls, branch points, APIs, or other technologies that provide for the partitioning or modularization of particular processing or control functions. Components or modules may be combined via their interfaces with other components to carry out a machine process. A component or module may be a packaged functional hardware unit designed for use with other components and a part of a program that usually performs a particular function of related functions. Components or modules may constitute either software components (e.g., code embodied on a machine-readable medium) or hardware components. A “hardware component” or “hardware module” is a tangible unit capable of performing certain operations and may be configured or arranged in a certain physical manner. In various examples, one or more computer systems (e.g., a standalone computer system, a client computer system, or a server computer system) or one or more hardware components or software components of a computer system (e.g., a processor or a group of processors) may be configured by software (e.g., an application or application portion) as a hardware component or software component that operates to perform certain operations as described herein. A hardware component or hardware module may also be implemented mechanically, electronically, or any suitable combination thereof. For example, a hardware component hardware module may include dedicated circuitry or logic that is permanently configured to perform certain operations. A hardware component or hardware module may be a special-purpose processor, such as a field-programmable gate array (FPGA) or an application-specific integrated circuit (ASIC). A hardware component or hardware module may also include programmable logic or circuitry that is temporarily configured by software to perform certain operations. For example, a hardware component or hardware module may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component or hardware module mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components or hardware modules can provide information to, and receive information from, other hardware components. Accordingly, the described hardware components or hardware modules may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component or hardware module may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems. Additional claimable subject matter further includes the following:

Example 1 is a computing device comprising: one or more processors; and one or more memories storing instructions that, when executed by the one or more processors, configure the one or more processors to perform operations comprising: rendering a three-dimensional (3D) model and trainable 3D texture to generate a first two-dimensional (2D) image; adding noise to the first 2D image to generate a first 2D image with added noise; inputting the first 2D image with added noise and input text into a trained neural network to generate a predicted noise of the first 2D image with added noise; determining a loss between the first 2D image with added noise and the predicted noise; and updating the trainable 3D texture based on the loss.

In Example 2, the subject matter of Example 1 includes, wherein determining the loss further comprises: determining the loss based on a difference between the first 2D image with added noise and the predicted noise.

In Example 3, the subject matter of Example 2 includes, wherein the operations further comprise: determining a gradient based on the loss; backpropagating the gradient through the first 2D image with added noise; backpropagating the gradient through the 3D trainable texture; and updating the trainable 3D texture based on the gradient.

In Example 4, the subject matter of Example 3 includes, D image with added noise further comprises: subtracting the predicted noise from the first 2D image with added noise.

In Example 5, the subject matter of any one of Examples 3-4 includes, wherein rendering further comprises: rendering, using a differential renderer component, the 3D model and the trainable 3D texture to generate the first 2D image.

In Example 6, the subject matter of Example 5 includes, wherein the operations further comprise: propagating the gradient through the differential renderer component.

In Example 7, the subject matter of any one of Examples 1-6 includes, D images based on input texts, and the trained neural network comprises one or more of: convolutional layers, one or more up sampling layers, one or more down sampling layers, and one or more fully connected layers.

In Example 8, the subject matter of Example 7 includes, wherein the trained neural network is trained using a diffusion method.

In Example 9, the subject matter of any one of Examples 1-8 includes, D texture further comprises: selecting a camera angle; and rendering the 3D model and trainable 3D texture based on the camera angle to generate the first 2D image.

In Example 10, the subject matter of Example 9 includes, wherein the operations further comprise: selecting one or more lighting sources, wherein the rendering is further based on the one or more lighting sources.

In Example 11, the subject matter of any one of Examples 9-10 includes, D image further comprises: modifying the input text in accordance with the camera angle; and inputting the first 2D image with added noise and the modified input text into the trained neural network to generate the predicted noise.

In Example 12, the subject matter of any one of Examples 10-11 includes, wherein the operations further comprise: wherein the inputting the first 2D image further comprises: modifying the input text in accordance with the one or more lighting sources; and inputting the first 2D image with added noise and the modified input text into the trained neural network to generate the predicted noise.

In Example 13, the subject matter of any one of Examples 1-12 includes, wherein adding noise further comprises: determining Gaussian noise for the first 2D image; and adding the Gaussian noise to the first 2D image to generate the first 2D image with the added noise.

In Example 14, the subject matter of any one of Examples 1-13 includes, wherein determining Gaussian noise further comprises: sampling a Gaussian distribution to determine the noise, wherein an amount of the noise is based on a number of iterations of updating the trainable 3D texture.

In Example 15, the subject matter of any one of Example 14 includes, D image further comprises: inputting the first 2D image with added noise, the input text, and the number of iterations into the trained neural network to generate the predicted noise of the first 2D image with added noise.

In Example 16, the subject matter of any one of Examples 1-15 includes, wherein the operations further comprise: repeating the rendering, the adding, the inputting, the determining, and the updating, until the loss transgresses a threshold value.

Example 17 is a non-transitory computer-readable storage medium including instructions that, when processed by one or more processors, configure the one or more processors to perform operations comprising: rendering a three-dimensional (3D) model and trainable 3D texture to generate a first two-dimensional (2D) image; adding noise to the first 2D image to generate a first 2D image with added noise; inputting the first 2D image with added noise and input text into a trained neural network to generate a predicted noise of the first 2D image with added noise; determining a loss between the first 2D image with added noise and the predicted noise; and updating the trainable 3D texture based on the loss.

In Example 18, the subject matter of Example 17 includes, wherein determining the loss further comprising: determining the loss based on a difference between the first 2D image with added noise and the predicted noise.

Example 19 is a method performed by one or more processors comprising: rendering a three-dimensional (3D) model and trainable 3D texture to generate a first two-dimensional (2D) image; adding noise to the first 2D image to generate a first 2D image with added noise; inputting the first 2D image with added noise and input text into a trained neural network to generate a predicted noise of the first 2D image with added noise; determining a loss between the first 2D image with added noise and the predicted noise; and updating the trainable 3D texture based on the loss.

In Example 20, the subject matter of Example 19 includes, wherein determining the loss further comprising: determining the loss based on a difference between the first 2D image with added noise and the predicted noise.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. A computing device comprising:
one or more processors; and
one or more memories storing instructions that, when executed by the one or more processors, configure the one or more processors to perform operations comprising:
rendering a three-dimensional (3D) model and trainable 3D texture to generate a first two-dimensional (2D) image;
adding noise to the first 2D image to generate a first 2D image with added noise;
inputting the first 2D image with added noise and input text into a trained neural network to generate a predicted noise of the first 2D image with added noise;
determining a loss between the first 2D image with added noise and the predicted noise; and
updating the trainable 3D texture based on the loss.

2. The computing device of claim 1, wherein determining the loss further comprises:
determining the loss based on a difference between the first 2D image with added noise and the predicted noise.

3. The computing device of claim 2, wherein the operations further comprise:
determining a gradient based on the loss;
backpropagating the gradient through the first 2D image with added noise;
backpropagating the gradient through the 3D trainable texture; and
updating the trainable 3D texture based on the gradient.

4. The computing device of claim 3, wherein the backpropagating the gradient through the first 2D image with added noise further comprises:
subtracting the predicted noise from the first 2D image with added noise.

5. The computing device of claim 3, wherein rendering further comprises:
rendering, using a differential renderer component, the 3D model and the trainable 3D texture to generate the first 2D image.

6. The computing device of claim 5, wherein the operations further comprise:
propagating the gradient through the differential renderer component.

7. The computing device of claim 1, wherein the trained neural network is trained, using a diffusion model, to generate 2D images based on input texts, and the trained neural network comprises one or more of: convolutional layers, one or more up sampling layers, one or more down sampling layers, and one or more fully connected layers.

8. The computing device of claim 1, wherein the operations further comprise:
receiving the input text and the 3D model from a user.

9. The computing device of claim 1, wherein rendering the 3D model and trainable 3D texture further comprises:
selecting a camera angle; and
rendering the 3D model and trainable 3D texture based on the camera angle to generate the first 2D image.

10. The computing device of claim 9, wherein the operations further comprise:
selecting one or more lighting sources, wherein the rendering is further based on the one or more lighting sources.

11. The computing device of claim 9, wherein the inputting the first 2D image further comprises:
modifying the input text in accordance with the camera angle; and
inputting the first 2D image with added noise and the modified input text into the trained neural network to generate the predicted noise.

12. The computing device of claim 10, wherein the inputting the first 2D image further comprises:
modifying the input text in accordance with the one or more lighting sources; and
inputting the first 2D image with added noise and the modified input text into the trained neural network to generate the predicted noise.

13. The computing device of claim 1, wherein adding noise further comprises:
determining Gaussian noise for the first 2D image; and
adding the Gaussian noise to the first 2D image to generate the first 2D image with the added noise.

14. The computing device of claim 1, wherein determining Gaussian noise further comprises:
sampling a Gaussian distribution to determine the noise, wherein an amount of the noise is based on a number of iterations of updating the trainable 3D texture.

15. The computing device of claim 14, wherein the inputting the first 2D image further comprises:
inputting the first 2D image with added noise, the input text, and the number of iterations into the trained neural network to generate the predicted noise of the first 2D image with added noise.

16. The computing device of claim 1, wherein the operations further comprise:
repeating the rendering, the adding, the inputting, the determining, and the updating, until the loss transgresses a threshold value.

17. A non-transitory computer-readable storage medium including instructions that, when processed by one or more processors, configure the one or more processors to perform operations comprising:
rendering a three-dimensional (3D) model and trainable 3D texture to generate a first two-dimensional (2D) image;
adding noise to the first 2D image to generate a first 2D image with added noise;
inputting the first 2D image with added noise and input text into a trained neural network to generate a predicted noise of the first 2D image with added noise;
determining a loss between the first 2D image with added noise and the predicted noise; and
updating the trainable 3D texture based on the loss.

18. The non-transitory computer-readable storage medium of claim 17, wherein determining the loss further comprising:
determining the loss based on a difference between the first 2D image with added noise and the predicted noise.

19. A method performed by one or more processors comprising:
rendering a three-dimensional (3D) model and trainable 3D texture to generate a first two-dimensional (2D) image;
adding noise to the first 2D image to generate a first 2D image with added noise;
inputting the first 2D image with added noise and input text into a trained neural network to generate a predicted noise of the first 2D image with added noise;
determining a loss between the first 2D image with added noise and the predicted noise; and
updating the trainable 3D texture based on the loss.

20. The method of claim 19, wherein determining the loss further comprising:
determining the loss based on a difference between the first 2D image with added noise and the predicted noise.
